(19) United States
(12) Patent Application Publication
(10) Pub. No.: US 2005/0074653 A1
(43) Pub. Date: Apr. 7, 2005

(54) Redox cell with non-selective permionic separator

(75) Inventors: Barry M Broman, Kirkland, WA (US); Alberto Pellegri, Castelveccana (IT)

Correspondence Address: CONNOLLY BOVE LODGE & HUTZ LLP, SUITE 800, 1990 M STREET NW, WASHINGTON, DC, 20036-3425, US

(73) Assignee: SQUIRREL HOLDINGS LTD., Cayman Islands (KY)

(21) Appl. No.: 10/482,575

(22) PCT Filed: Jun. 26, 2002
(86) PCT No.: PCT/IT02/00424

(30) Foreign Application Priority Data
Jun. 28, 2001 (IT) VA2001A000019

(51) Int. Cl. H01M 8/20; H01M 8/10

(52) U.S. Cl. 429/33; 429/105

(57) ABSTRACT

The ohmic losses in a redox cell, composed of a positive electrode inside a flow compartment of a positive halfcell acid electrolytic solution, a negative electrode inside a flow compartment of a negative halfcell acid electrolytic solution and a fluid impermeable membrane composed at least partially of an ion exchange resin separating said flow compartments of the respective halfcell electrolytic solution, may be reduced by using a membrane of mixed characteristics. The ion exchange resin of the membrane includes both a cation exchange resin and anion exchange resin allowing the migration through the membrane of anions as well as of protons (H⁺) of said acid electrolytic solutions.

The present invention relates to electrochemical energy storage system for renewable energy sources employing batteries of redox cells.

Among so-called secondary batteries, the redox battery permits to store energy in chemical form in the electrolytic solutions themselves without causing the electrodes to undergo any physical-chemical change.

The use of redox couples of compatible elements in the two electrolytic solutions of the positive halfcell and of the negative halfcell, respectively, or even better the use of the redox couples of the same multivalence element, offers a great simplification in the handling and storage of the charged solutions.

WO99/39397 describes an all vanadium redox battery system.

The cell voltage required for charging the system and the discharge voltage of the cell are given, in first approximation, by the following equations:
E⁰_{cell}=E⁰_{cathode}−E⁰_{anode}−iR−nₐ−n_{c} E⁰_{cell}=E⁰_{cathode}−E⁰_{anode}+iR+nₐ+n_{c}

While the terms E⁰_{cathode} and E⁰_{anode}, representing the standard halfcell potentials, depend on the state of charge of the electrolytic solution of the positive halfcell and of the electrolytic solution of the negative halfcell (at a certain temperature of operation), the other terms of the equations represent kinetic limits of the electrochemical reactions and the voltage drops through the cells upon the passage of an electric current.

While the values of the kinetic terms nₐ and n_{c} may be reduced by improving the catalytic activity of the electrodes (cathode and anode), the term iR may be optimized by reducing the resistivity of the electrodic structures, typically of glassy carbon (amorphous carbon), graphite and similar carbon-base materials, and by reducing the voltage drops due to the ions migration of the electrolytes in the cell.

In these systems, the fluid impermeable membrane made of an ion exchange resin constitutes a solid electrolyte of the cell, in view of the fact that it must support ion migration from an electrolytic solution in one compartment to the electrolytic solution in the other compartment of the cell, that is from an electrode to the counter electrode of the cell.

Even in cells wherein the ionic current involves ion migration through the bulk of one of or both the electrolytic solutions that are circulated in respective compartments of the cell in contact with respective electrodes, the preponderant part of voltage drop through the cell is imputed to ion migration through the thickness of the permionic membrane used for separating the electrolytic solution of the positive halfcell (shortly positive electrolyte) from the electrolytic solution of the negative halfcell (shortly negative electrolyte).

According to known techniques, it is common practice to employ as the permionic separator of a cell an ion exchange membrane of either one or the other type, that is either a cationic membrane suitable to support migration of cations through it, such as for example a nafion® membrane (trademark of Du Pont de Nemours) that contain fit sulfonic and/or carboxylic acid groups linked to a polyolefinic backbone structure, or alternatively an anionic membrane, for example of a polymer or co-polymer containing aminic groups linked to a polymeric backbone structure for example a polyethylene, polyester and the like.

The introduction of anionic or cationic groups in a preformed polymeric film may be made by known processes of sulfo-cloruration, sulfonation, amination.

Alternatively, anionic or cationic groups or precursor compounds may be preliminarily cross-linked with monomers such as divinylbenzene (DVD) for making them insoluble and co-polymerizable in order to obtain the polymeric material with which laminate the membranes to be rendered permionic by hydrolysing the precursor compounds.

So-called heterogeneous membranes are also known and used in redox cell. These membranes are constituted of a physical-chemical aggregation of an ion exchange resins (either cationic or anionic) with a support material, usually porous, for example a microporous fabric having the function of a matrix structure. The so-called Memtec method of the homonymous company Memtec Ltd., is an example of such a type of heterogeneous anionic or cationic membranes.

Among the innumerable publications on permionic membrane technology and on redox batteries the following may be cited as particularly significative:
1) Proceedings on the Third International Conference on Batteries for Utility Energy Storage, Kobe, Japan, 1991.
2) Proceedings of Symposium on Stationary Energy Storage: Load Levelling Remote Applications, Electrochemical Society, 1987.
3) Winston Ho, W. S. and Sirkar, K. K., Membrane Handbook, 1992.
4) Proceedings of the Symposium on Ion Exchange Transport and Interfacial properties, The Electrochemical Society, 1981.
5) Ruckenstein, E. and Chen, H. H., J. Applied Polymer Science, 42, 2429, 1991.
6) Ruckenstein, E. and Chen, H. H., J. Membrane Science, 66, 205, 1992.
7) EP 0 790 658.
8) WO 97/41168.

The numerous known techniques of polymerisation and/or co-polymerisation and the innumerable formulations of ion exchange membranes, substantially impermeable to hydrodynamic flow, are not the objects of the present invention and a discussion thereof, even in summary form does not appear to be necessary for fullest comprehension of the present invention. It may be said that any known technique of polymerisation or co-polymerisation and any known formulation of ion exchange resin may be exploited in the practice of the present invention.

It should be remarked that according to the prior art in case of a cationic membrane, either of a homogeneous or heterogeneous type, the ionic current through the redox cell is supported by the migration of protons (H⁺) through a cationic membrane, while in the case of an anionic membrane, the ionic current through the cell is supported by the migration of anions (for example SO₄⁻) of the acid electrolyte (sulfuric acid) through the anionic membrane.

Because the ions migrating through the ion exchange membrane separator of the cell from a compartment to the other compartment together with a shell (cloud) of polar molecules of the solvent, typically water, the different hydration states of the ion (for example of protons H⁻) at the different pH condition during the charging and discharging processes of the redox battery, that is of the respective positive and negative electrolytes, and other phenomena also depending on the variable conditions of acidity of the electrolytic solutions in contact with the permionic membrane and on the temperature of operation tend to volumetrically unbalance the two electrolytic solutions, a phenomenon that imposes periodic interventions for re-establishing a correct volumetric balance, with attendant efficiency losses.

In the above mentioned document WO 99/39397, in order to alleviate such a phenomenon, the use is disclosed of cells employing as separator cationic membranes and of cells employing as separator anionic membranes.

Resistivity (as refer to the passage of a ionic current) of cationic membranes as far as of anionic membranes depends on the kind of polymeric backbone as well as of the kind of the fixed polar groups that confer to the membrane the required ion exchange properties, as well as from the density and uniformity of their distribution in the bulk of the resin film, besides from the degree of hydrolization of such fixed polar groups.

It has now been surprisingly found that neither the charging process nor the discharge process of a redox cell is in any way negatively affected if the separator of each simple cell is made permeable to migration of both anions as well as of cations.

It has been noticed that by using a permionic membrane having substantially mixed characteristic, that is by conferring to the membrane the ability of supporting migration of anions as well as of supporting migration of cations (typically protons H⁺), though in both cases always through an ion exchange mechanism, the voltage drop across the membrane during the charging phase as well as during the discharging phase at a given current density, is significatively reduced.

Moreover, the progressive volumetric unbalancing phenomenon of the two electrolytic solutions in their respective hydraulic circuits may be reduced to the point of resulting practically negligible.

These results have been demonstrated sperimentally by employing in a test cell a fluid impermeable permionic separator that was made in part, that is for a certain fraction of the cell area, by a cationic membrane and in part, that is for the other fraction of the cell area, by an anionic membrane and by varying the area ratio between the two parts of the permionic separator of the cell.

By fabricating a membrane impermeable to hydraulic flow and with mixed ion exchange characteristic, for example in a heterogeneous form by mixing cationic resin and anionic resin and laminating the mixture to form a mixed characteristic membrane permeable to both cations and anions, the reduction of resistivity is even more noticeable at varying conditions of concentrations of the two electrolytic solutions of the cell and of current density forced through the cell during a charging phase as well as during a discharge phase.

The same advantageous effects may be obtained even by fixing on the same polymeric or co-polymeric backbone anionic groups and cationic groups thus realizing a homogeneous membrane having mixed ion exchanging characteristics, quantitatively depending on the number of polar groups of one type and of the other type that are fixed to the polymeric backbone structure for unit of area of the membrane.

In practice, any suitable ion exchange membrane formulation or composite structure comprising for example a microporous support that is subsequently impregnated with a mixture of cationic ion exchange resin and of anionic ion exchange resin making it impermeable to fluid flow, such to form a permionic membrane with chemical resistance to the electrolytic solutions used in the redox battery, may be exploited for achieving the objectives and the advantageous results of the present invention.

It is also evident that the ion exchange capacity of the cationic resin as well as of the anionic resin or of the polymer or co-polymer on which are fixed (e.g. cross-linked) polar cationic group and polar anionic groups, is tied to the density per unit volume or unit area of the laminated article of the polar groups of one and of the other type. These specific densities of cationic groups and of anionic groups, in function of the other characteristics of the polymeric or co-polymeric backbone to which are linked, determine a relatively high ion exchange capacity through the membrane of both anions and of cations migrating under the effect of the cell voltage from the positive to the negative electrolyte of the redox battery and viceversa.

What this invention surprisingly achieves is that, for resin with comparable ion exchange characteristics, the presence in the membrane of both type of polar groups instead of only one, determines a marked lowering of the ionic resistivity with a consequent lowering of the voltage drop through the cell at a given current density, both during a charging phase as well as during a discharging phase.

Such advantageous results achieved by employing a membrane with mixed characteristics of ion transport used as cell separator of a redox battery has been demonstrated, though in a peculiar and certainly not optimized manner, by using a test cell in which the ion exchange separator, instead of being of a unique type, was purposely composed of two different commercial membranes, one anionic and the other cationic. The laboratory test cell had the permionic separator that could be installed in a frame in which two distinct windows were defined for two distinct membranes cut to the size of the respective window. In a first test run the two windows were of identical area.

The frame for assembling the two-part membrane separator was usually sandwiched between the perimetral flanges of two halfcell bodies, each provided with an inlet and an outlet duct for the respective electrolytic solution and containing a glassy carbon plate on the surface of which a felt of carbon fibres was bonded in a way to ensure a substantially perfect electrical continuity between the glassy carbon support plate and the fibres of the carbon felt bonded on the face facing towards the membrane and the counter electrode of the cell of identical structure held inside the other compartment of the cell.

The two electrodes were connected to the external circuit by way of ordinary laboratory test fixtures.

The membranes used for the test were both commercially available. The cationic membrane was Nafion® N 117, marketed by Dupont de Nemours.

The anionic membrane was AMW marketed by Ionix Inc.

Comparative “blank” data were preliminarily gathered by employing as permionic separator the cationic membrane Nafion® N 117 and subsequently the anionic membrane AMW (that is by installing the same type of membrane in both windows of the membrane frame).

The hydraulic circuits of the positive electrolyte and of the negative electrolyte of the redox battery were initially filled with an electrolytic solution consisting of an aqueous solution containing Vanadium (1.8 moles/litre) as acid sulphate 5 moles.

The current density during the charging phase as well as during the discharging phase was maintained constant at 0.03 A/cm².

The conditions of thermal balance both during the charging and the discharging phases of the battery at such current density were such to imply a variation of the temperature of the electrolyte in the compartments of the cell generally comprised between 30 and 40° C.

After recording the operating data of the battery equipped with cationic membrane and successively equipped with anionic membrane at the above-noted operating conditions, the redox cell was again disassembled and in the two windows of the membrane frame were installed respectively the same cationic membrane suitably cut to size that had been used during the first preliminary test run for comparison purposes and the same anionic membrane also cut to size that was used during the other preliminary test run.

After having reset the initial conditions, the operating characteristics of the redox cell so equipped with the ion exchange separator, half of which of cationic type and half of which of anionic type have been recorded.

The operating data for the various test run of 20 charge/discharge cycles are shown in the following table for an immediate comparison.

TABLE 1

| | | | | | | | NET |
|---|---|---|---|---|---|---|---|
| | | | | | | VOLUMETRIC | VOLUMETRIC |
| | | | | | | UNBALANCING | UNBALANCING |
| | | | CELL VOLTAGE | | | OF THE | OF THE |
| | | | (V) | | | POSITIVE | POSITIVE |
| PERMIONIC | | TEMP. | State of charge | | | ELECTROLITE | ELECTROLITE |
| SEPARATOR | MODE | (° C.) | 20% | 50% | 80% | (cm³) | (cm³) |
| Cationic | Charge | 32 | 1.43 | 1.51 | 1.59 | −72 | +9 |
| Membrane | Discharge | 36 | 1.13 | 1.19 | 1.25 | +81 | |
| Anionic | Charge | 32 | 1.49 | 1.55 | 1.63 | −13.5 | −3 |
| Membrane | Discharge | 38 | 1.07 | 1.15 | 1.22 | +10.8 | |
| Mixed | Charge | 32 | 1.41 | 1.49 | 1.58 | −38.6 | −1.7 |
| Membrane | Discharge | 36 | 1.15 | 1.20 | 1.28 | +36.9 | |

Confirming the intuition at the base of the present invention, the data relative to the test run made with a permionic separator, substantially of mixed characteristics, indicated clearly a marked advantage in term of reduced ohmic drop both during the charging as well as during the discharging process and a reduced volumetric unbalancing between the two electrolytic solutions at the end of the 20 charge/discharge cycles.

At this point, the membrane frame divided in two windows of equal area was substituted with a different membrane frame, the window of which where was installed the anionic membrane had an area three times greater than the area in which the cationic membrane was installed.

The operating data of a cell so equipped with different membranes and with a different effective area ratio, during a test run of 20 charge/discharge cycles, are shown in the following table 2.

TABLE 2

| | | | | | | | NET |
|---|---|---|---|---|---|---|---|
| | | | | | | VOLUMETRIC | VOLUMETRIC |
| | | | | | | UNBALANCING | UNBALANCING |
| | | | CELL VOLTAGE | | | OF THE | OF THE |
| | | | (V) | | | POSITIVE | POSITIVE |
| PERMIONIC | | TEMP. | State of charge | | | ELECTROLITE | ELECTROLITE |
| SEPARATOR | MODE | (° C.) | 20% | 50% | 80% | (cm³) | (cm³) |
| Mixed | Charge | 32 | 1.39 | 1.48 | 1.55 | −43.5 | +1.5 |
| Membrane | Discharge | 36 | 1.16 | 1.22 | 1.29 | +45.0 | |
| (ratio 1:1) | | | | | | | |
| Mixed | Charge | 32 | 1.38 | 1.48 | 1.54 | +28.3 | +0.3 |
| Membrane | Discharge | 36 | 1.16 | 1.23 | 1.30 | −28.0 | |
| (ratio 1:3) | | | | | | | |

As it may be observed, the correction of the area ratio between the installed cationic membrane and anionic membrane portions of the separator permitted to make the volumetric unbalancing between the two electrolytic solutions at the end of the 20 charge/discharge cycles practically negligible.

It is evident as a test cell so configured represents a penalizing (far from optimal) embodiment of the present invention because the geometric separation between a first fraction of area having a cationic membrane and a second fraction of area having an anionic membrane, notwithstanding the intermixing due to the flow of the electrolytic solutions through the respective compartments of the cell in contact with the permionic separator so divided in two areas of different characteristics, induces polarization gradient from a portion of area of the cell to another portion of area of the cell and this situation theoretically should decrease the advantages that may be achieved in term of an increased ionic conductivity and consequent lowering of the voltage drop through the cell both in charging as well as in discharging, compared to other embodiments.

Nevertheless, these preliminary experimental observations permit to anticipate with a good degree of certainty that in case of a more effective embodiment of this invention that is through the fabrication of a membrane with mixed characteristics of ion transport, no longer geometrically separated into distinct areas, but intimately intermixed, will produce even more marked effects of reduction of the voltage drop through the cell, besides permitting to nullify the volumetric unbalancing by simply optimizing the ratio between the number of cationic polar groups and the number of anionic polar groups contained in the membrane.

1 A redox cell composed of a positive electrode inside a flow compartment of a positive halfcell acid electrolytic solution, a negative electrode inside a flow compartment of a negative halfcell acid electrolytic solution and a fluid impermeable membrane composed at least partially of an ion exchange resin separating said flow compartments of the respective halfcell electrolytic solution, characterized in that
said ion exchange resin has mixed ion exchanging properties supporting both the exchange of cations and of the anions for allowing the migration through the fluid impermeable membrane of anions as well as of protons (H⁺) of said acid electrolytic solutions.

2 The cell of claim 1, wherein said acid electrolytic solution belongs to the group composed of solutions of sulfuric acid, sulfonic acid, boric acid, ossalic acid, nitric acid and mixtures containing at least one of the acids.

3 The cell of claim 1, wherein said cation exchange resin
belongs to the group composed of styrene, mono-divinylbenzene, polyvinyldene, polyethylene, polypropylene, polytetrafluoroethylene, polyvinylchloride, polyester, containing sulfonic or carboxylic groups and
said anion exchange resin belongs to the group composed of styrene, mono-divinylbenzene, polyvinyldene, polyethylene, polypropylene, polytetrafluoroethylene, polyvinylchloride, polyester, containing aminic group.

4 The redox cell of claim 1, wherein said positive halfcell electrolytic solution contains a redox couple of V(V)/V(IV) and said negative halfcell electrolytic solution contains a redox couple of V(III)/V(II).
